(19) United States
(12) Patent Application Publication
(10) Pub. No.: US 2009/0162585 A1
(43) Pub. Date: Jun. 25, 2009

(54) JEJUNAL FEEDING TUBE

(75) Inventors: Jeffry S. Melsheimer, Springville, IN (US); David A. Drewes, JR., Bloomington, IN (US)

Correspondence Address: BRINKS HOFER GILSON & LIONE/CHICAGO/COOK, PO BOX 10395, CHICAGO, IL, 60610, US

(73) Assignees: Cook Incorporated, Bloomington, IN (US); Sabin Corporation, Bloomington, IN (US)

(21) Appl. No.: 12/337,394

(22) Filed: Dec. 17, 2008

Related U.S. Application Data
(60) Provisional application No. 61/016,098, filed on Dec. 21, 2007.

(51) Int. Cl. B29D 23/00

(52) U.S. Cl. 428/34.1; 264/177.16

(57) ABSTRACT

The present invention provides a method of manufacturing a flexible tube. The method includes the steps of providing a source of material to be extruded and forming a tubular member with an extrusion die. The extrusion die includes a radially and outwardly extending tooth configured to define a protrusion upon the outer surface of the tubular member. The method further includes the step of rotating the tubular member after exiting the extrusion die such that the protrusion forms a helical profile along the length of the tubular member.

### CROSS REFERENCE TO RELATED APPLICATIONS

This application claims priority from U.S. Provisional Application No. 61/016,098, entitled “Jejunal Feeding Tube,” filed on Dec. 21, 2007, the entirety of which is fully incorporated by reference herein.

### TECHNICAL FIELD

The present invention relates to gastrostomy or jejunal devices, feeding tubes, or devices that may be inserted and retained within a patient for an extended period of time.

### BACKGROUND

Often it becomes medically necessary to implant an external feeding tube (or a similar gastrostomy device) into the gastrointestinal (“GI”) tract to provide nourishment when the patient cannot receive food and liquid by the normal method of oral intake.

A feeding tube is normally provided to provide nutritional support for patients with inadequate oral intake capability. The feeding tube may be inserted through the nasal cavity, percutaneously, or through other passages, and ultimately positioned within the GI tract for delivering nourishment thereto. This method of nourishment may be required for patients that suffer from neurological disorders, pulmonary disease, or head, neck, or esophageal lesions. In addition, nourishment directly to the patient's GI tract through the abdomen may be required when the patient exhibits decreased gastric motility, whether because of diabetic gastropathy, scleroderma, or other causes.

Specifically, the feeding tube may be disposed to supply nutrients to the jejunum after insertion through the patient's nasal passage, percutaneously through a stoma disposed upon the abdomen, or through another convenient location. After insertion either through the nasal cavity or percutaneously, the feeding tube is ultimately advanced through the patient's anatomy, through the pylorus, the duodenum, and rests with the distal end portion proximate the Ligament of Treitz. The feeding tube may be advanced through the patient manually and/or as aided by the peristaltic motion of the gastro-intestinal tract. The peristaltic motion of the gastro-intestinal tract aids in the insertion of the feeding tube into the predetermined location within the tract and has a tendency to keep it positioned in the desired location after insertion.

### BRIEF SUMMARY

The present invention provides a medical device for use as a gastrostomy or a gastrojejunostomy feeding device.

The present invention additionally provides a flexible tube. The flexible tube includes a distal end, a proximal end, and a lumen extending therebetween. The tube additionally includes an outer surface of a tube wall circumferentially defining the lumen, and a raised portion substantially helically extending between the proximal and distal ends, wherein the raised portion is monolithically formed within the tube wall.

The present invention additionally provides a method of manufacturing a flexible tube. The method includes the steps of providing a source of material to be extruded and forming a tubular member with an extrusion die. The extrusion die includes a radially and outwardly extending channel configured to define a protrusion upon the outer surface of the tubular member. The method further includes the step of rotating the tubular member after exiting the extrusion die such that the protrusion forms a substantially helical profile along the length of the tubular member.

The present invention additionally provides an apparatus for manufacturing a tube. The apparatus includes a distribution member configured to receive and transport a quantity of flowing material therethrough and an extrusion die comprising a wall defining a lumen with an inner substantially cylindrical surface of the wall. A channel extends radially from the inner substantially cylindrical surface into the wall. The die is configured to receive the flowing material from the distribution member and produce a tubular structure with a protrusion along its length. A first belt and a second belt are each disposed to receive the tubular structure after exiting the extrusion die, wherein the first and second belts each contact a substantially opposite outer surface of the tubular structure, wherein the first belt is disposed at a first oblique angle with respect to a longitudinal axis of the tubular member, and the second belt is disposed at a second oblique angle with respect to the longitudinal axis on an opposite side of the longitudinal axis from the first belt.

The present invention additionally provides a flexible tube. The flexible tube includes a distal end portion, a proximal end portion, and a lumen extending therebetween. A tube wall circumferentially defines the lumen and an outer surface surrounding the tube wall. An indentation substantially helically extends between the distal and proximal end portions, wherein the indentation is monolithically formed within the tube wall.

Advantages of the present invention will become more apparent to those skilled in the art from the following description of the preferred embodiments of the invention that have been shown and described by way of illustration. As will be realized, the invention is capable of other and different embodiments, and its details are capable of modification in various respects. Accordingly, the drawings and description are to be regarded as illustrative in nature and not as restrictive.

### BRIEF DESCRIPTION OF THE DRAWINGS

FIG. 1 is a perspective view of a feeding tube.

FIG. 2 is a perspective view of another feeding tube.

FIG. 3 is a perspective view of yet another feeding tube.

FIG. 4 is a perspective view of an apparatus to manufacture the feeding tube of FIG. 1.

FIG. 5a is a sectional view of a feeding tube.

FIG. 5b is a sectional view of another feeding tube.

FIG. 5c is a sectional view of yet another feeding tube.

FIG. 5d is a sectional view of still another feeding tube.

FIG. 5e is a sectional view of a feeding tube with a collapsible protrusion.

FIG. 6 is a sectional view of yet still another feeding tube.

FIG. 7a is a sectional view of an extrusion die to form the feeding tube of FIG. 5a.

FIG. 7b is a sectional view of an extrusion die to form the feeding tube of FIG. 5b.

FIG. 7c is a sectional view of an extrusion die to form the feeding tube of FIG. 5c.

FIG. 7d is a sectional view of an extrusion die to form the feeding tube of FIG. 5d.

FIG. 7e is a sectional view of an extrusion die to form the feeding tube of FIG. 6.

FIG. 8 is a perspective view of a mandrel used with the apparatus of FIG. 4.

FIG. 9 is a top view of the first and second belts of the apparatus of FIG. 4.

FIG. 10 is a sectional view of FIG. 9 showing section 9-9.

FIG. 11 is a perspective view of an alternate die.

FIG. 12 is a perspective view of yet another die.

### DETAILED DESCRIPTION OF THE DRAWINGS AND THE PREFERRED EMBODIMENTS

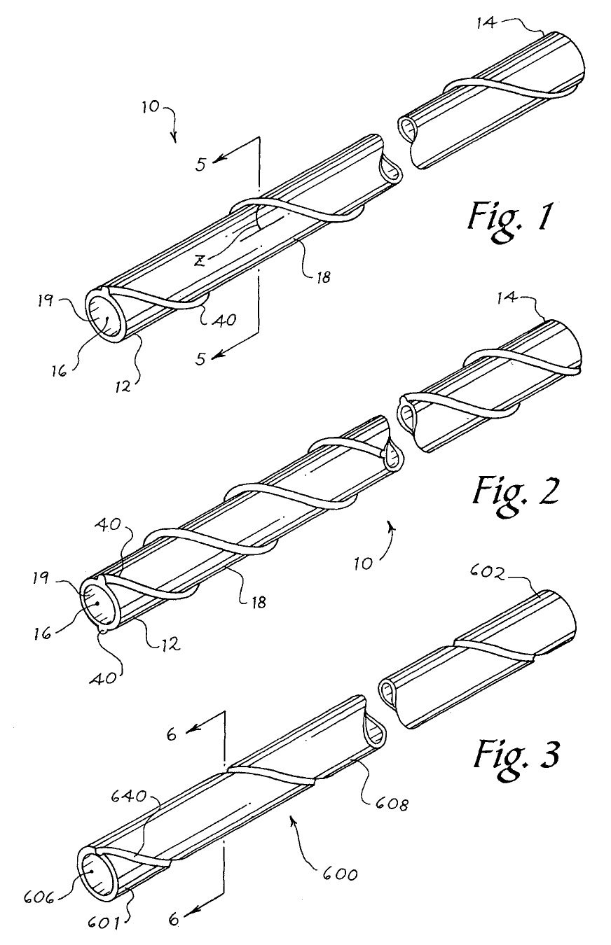

Turning now to FIGS. 1-10 a feeding tube 10 is provided. The feeding tube 10 is generally elongate and flexible and includes a distal end portion 12, a proximal end portion 14, and a lumen 16 extending therethrough between distal and proximal end portions 12, 14. Feeding tube 10 includes a substantially cylindrical outer surface 18, and a substantially cylindrical inner surface 19 that defines lumen 16. Feeding tube 10 includes at least one protrusion, or outwardly extending tactile feature 40 that radially outwardly extends from outer surface 18 of feeding tube 10 and extends between distal and proximal end portions 12, 14. In some embodiments, the protrusion 40 extends between distal and proximal end portions 12, 14 of tube 10 in a substantially helical pattern.

The protrusion 40 may be a single helical thread that extends between distal and proximal ends 12, 14 or in alternate embodiments shown in FIG. 2, multiple protrusions 40 may be formed on tube 10 and extend radially from the outer surface 18 of the tube 10 between distal and proximal ends 12, 14. In embodiments with multiple protrusions 40 disposed upon the outer surface of the tube 10, the protrusions 40 may be disposed with consistent spacing between neighboring protrusions 40 around the circumference of the tube 10. For example, in embodiments with two protrusions 40 disposed upon the outer surface of the tube 10, the protrusions 40 may be disposed at substantially opposite sides of the tube 10, with centers approximately 180 degrees apart. In other embodiments, the protrusions 40 may be disposed at varying locations around the outer surface of the tube 10.

The one or more protrusions 40 are disposed and circle the outer surface 18 of the tube 10 in a substantially helical pattern. In some embodiments, the one or more protrusions 40 may be disposed with a helix angle of between about 5 degrees and about 45 degrees. In other embodiments, the helix angle may be between about 15 degrees and about 30 degrees. In embodiments with a plurality of protrusions 40, the protrusions 40 are each disposed about the tube 10 at the same helical angles along the length of the tube 10.

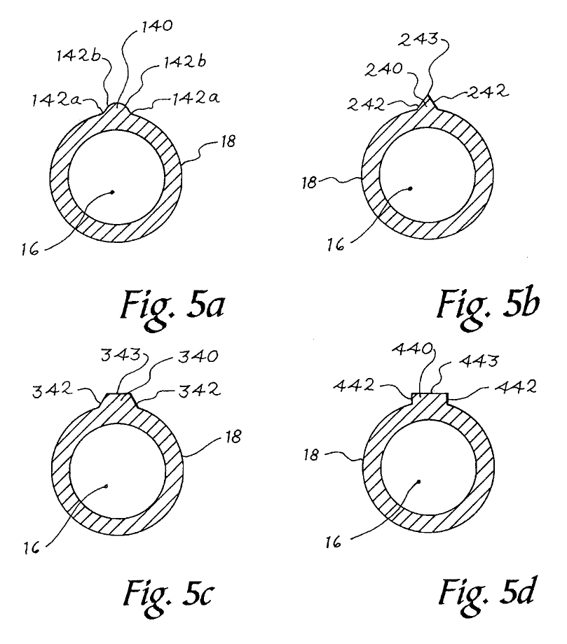

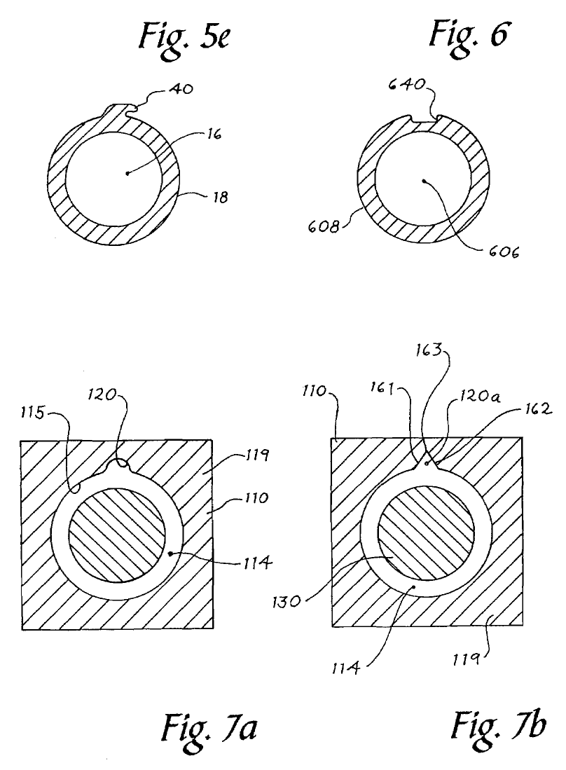

As shown in FIGS. 5a-5d, the one or more protrusions 40 may be formed upon the tube 10 with a plurality of different cross-sectional shapes. For example, a protrusion 140 may be semi-circular or formed as a portion of a circle defined by a chord as shown in FIG. 5a. In other embodiments shown in FIG. 5b, a protrusion 240 may be substantially triangular with opposing planar sides 242 that meet at an edge 243. In still other embodiments shown in FIG. 5c, a protrusion 340 may be trapezoidal with two angled side surfaces 342 that each meets with a top surface 343. As shown in FIG. 5d, a protrusion 440 may be substantially rectangular with two parallel side surfaces 442 that each connects with a substantially perpendicular top surface 443. As can be appreciated after reviewing the underlying specification, the protrusion 40 may be formed with a plurality of different shapes that radially project from the outer surface 18 of the tube 10 that are usefully in assisting with the retention of the tube 10 within the intended portion of the patient's anatomy.

In some embodiments, the protrusion 40 (140, 240, 340, 440) may be configured to connect with the outer surface 18 of the tube 10 with gradual, sloping surfaces. For example as shown in FIG. 5a, a protrusion 140 includes side walls 142 that define a curved portion 142a proximate and contacting the outer surface 18 of the tube 10 such that the curved portion 142a is substantially tangent to the tube wall 18 as well as an extended portion 142b of the side wall that radially extends away from the outer surface 18 of the tube 10. In other embodiments, the protrusion 40 may be attached to the outer surface 18 of the tube 10 with a defined edge or discontinuity.

The one or more protrusions 40 may be configured to include the same material properties as the material forming the cross-section of the tube 10 and to be monolithic with the other portions of the tube 10. In some embodiments, the one or more protrusions 40 may be configured to be at least partially collapsible toward the circumferential outer surface 18 of the tube 10. Upon insertion or placement, a portion or portions of the one or more protrusions 40 may fully or partially collapse toward the outer surface 18 of the tube 10 in response to compression between relatively hard portions of the anatomy that neighbor the tube 10 when inserted and properly positioned within the patient. The full or partial compression of the one or more protrusions, and other interaction with the patient's anatomy when inserted, allows the tube 10 to be maintained in the optimal position after insertion. Similarly as shown in FIG. 5e, because the one or more protrusions 40 are configured to be at least partially collapsible, the one or more protrusions 40 may collapse or deform when the tube 10 is placed in tension, which allows for the removal of the tube 10 from the patient when desired.

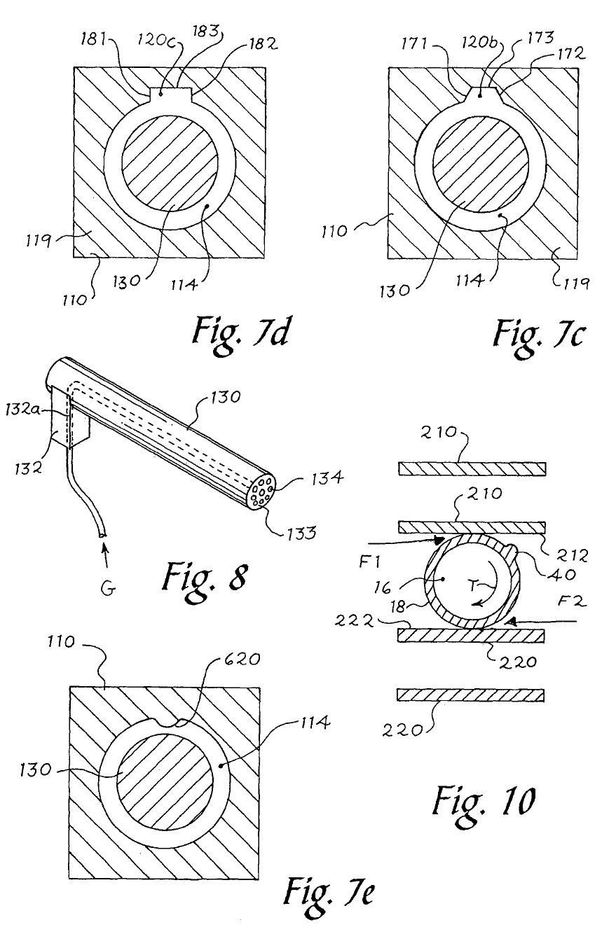

In other embodiments shown in FIGS. 3, 6, and 7e, an inwardly extending tactile feature, such as an indentation 640 may be defined within a tube 600, and specifically include a localized portion that forms an indentation 640 within the tube wall, which processes helically around the tube 600 in a similar fashion to the one or more protrusions 40 discussed above that process helically around the tube 10 discussed above. The tube 600 that includes an indentation 640 is extruded from an extrusion die 610 that includes an inwardly extending tooth 620 that radially extends toward the center of the die 610 from an inner cylindrical surface that defines a lumen 616 within the extrusion die 610. The lumen 616 is formed with the assistance of a mandrel 130 (similar to mandrels 130 discussed below). The tooth 620 may be formed to define an indentation that is semi-circular or formed as a portion of a circle defined by a chord as shown in FIG. 7e, or the tooth 620 may be sized and shaped to define an indentation 640 in the tube 600 with a plurality of different possible shapes (i.e. similar to the plurality of different shapes of the protrusions 40, 140, 240, 340, 440 and the like). The tube 600 includes a distal end portion 601, a proximal end portion 602, and a lumen defined therethrough 606.

Similar to the embodiments of the different possible protrusions 140, 240, 340, 440, the tube 600 may include an indentation 640 with a plurality of different shapes. For example, the indentation 640 may be substantially circular, or formed similar to a portion a circle defined by a chord, triangular, trapezoidal, or rectangular. The sides of the indentation 640 may be defined to form a gradual slope between the outer surface 608 of the tube 600 and the sides of the indentation, such as forming a substantially continuous curve between the outer surface 608 and the sides of the indentation 640. In other embodiments, the indentation 640 may form edges or other discontinuities with the outer surface 608 of the tube 600, or with other neighboring surfaces that define the indentation 640. In some embodiments, two or more indentations 640 may be defined within the tube 600. Similar to the tube 10 discussed herein, as the tube 600 leaves the extrusion die, the tube 600 is subsequently twisted by the first and second belts 210, 220 discussed above, such that the indention 640 helically processes around the length of the tube 600.

The tube 10, including the one or more protrusions 40, may be formed by an extrusion process with a single extrusion die 110. The extrusion die 110 is substantially cylindrical with an internal lumen 114 for receiving and allowing material to be pressed therethrough to form and shape outer surface 18 of tube 10. Flowing material (i.e. heated to a flowing liquid state with minimal viscosity) is presented to the inlet of the extrusion die 110 and is directed to enter the lumen 114 within the extrusion die 110. In some embodiments, the liquid material may be urged toward the extrusion die 110 with an Archimedes screw, or auger 312 within a heated barrel 310. Liquid material is directed to enter the barrel 310 and contacts the screw 312 (which includes a plurality of threads 312a that are sized to minimize the space between the inner surface of the barrel 310 and the threads 312a) such that rotation of the screw 312 urges the material within the barrel 310 toward the exit. The barrel 310 may include a breaker plate 340 that promotes mixing of the material flowing from the barrel 310. The material may then flow from the barrel 310 to the inlet of the die 110 through a pipe 350.

The extrusion die 110 further defines at least one channel 120 that projects radially from the inner cylindrical surface 115 of the die 110 radially into the wall 119 that defines the internal lumen 114. Channel 120 may be formed with various shapes that are configured to produce the various shaped protrusions (40, 140, 240, 340, 440) discussed above and shown in FIGS. 7a-7d. For example, as shown in FIG. 7b, channel 120a may be defined from first and second substantially flat walls 161, 162 that extend radially from internal lumen 114 and connect together to define an edge 163. In other embodiments shown in FIG. 7c, another channel 120b may be defined from first and second flat side walls 171, 172 that are each disposed at an oblique angle with respect to each other that each meets a flat top wall 173. In still other embodiments as shown in FIG. 7d, channel 120c may be defined from two substantially parallel walls 181, 182 that extend from the lumen 114 and are each connected together by a mutually perpendicular wall 183. Alternatively, channel 120 may be defined with other differing geometries.

The extrusion die 110 further comprises a mandrel 130 that is disposed within the extrusion die 110 to define the lumen 18 within the tube 10. The mandrel 130 may be substantially circular and disposed coaxially with the longitudinal axis of the extrusion die 110 such that the thickness of the tube 10 leaving the die 110 is substantially consistent around the entire circumference of the tube 10 (except for the portion of the tube 10 that includes the one or more protrusions 40). In other embodiments, two or more mandrels 130 may be disposed within the extrusion die 110 to define a like number of parallel lumens along the length of the tube 10.

As shown in FIG. 8, the mandrel 130 is rigidly connected to the extrusion die 110 with a leg 132 that is disposed at or proximate to an inlet aperture of the die 110. The leg 132 rigidly supports and aligns the mandrel 130 through the length of the extrusion die 110 in a cantilevered fashion. The leg 132 is positioned within the die 110 such that the portion of the inlet of the die 110 blocked by the leg 132 (and therefore not initially filled with flowing material) is limited as much as possible to minimize the discontinuity in the tube 10, while still providing a rigid connection of the mandrel 130 to the die 110. The die 110 and the mandrel 130 are configured such that material reflows within the die 110 after passing the leg 132 to fill the die 110 with material around the entire circumference of the mandrel 130. The die 110 is formed of a sufficient length to provide for material reflow around the entire circumference of the mandrel 130 such that the entire circumference of the tube 10 is formed prior to leaving the die 110.

Further, the temperature and viscosity of the material entering the die 110 should be closely monitored and controlled such that the material reflow to fully enclose the lumen 116 after passing the leg 132 of the mandrel 130, while sufficiently cooling within the die 110 prior to sufficiently harden prior to exiting the die 110 such that the tube 10 maintains the designed cross-section and the integrity of the lumen 16 defined within the tube 10. In some embodiments, a cooling gas G is pumped from a plurality of ports 134 on the proximal end surface 133 of the mandrel 130 and into the lumen 16 of the tube 10 as the tube 10 exits the extrusion die 110, which provides a positive pressure within the lumen 16 upon leaving the die 110 to resist deformation of the lumen 16 (which would potentially further increase the pressure therein) and additionally cooling the internal surface of the tube 10. As shown in FIG. 8, the cooling gas G enters the mandrel 130 through the leg 132, specifically through a lumen 132a defined within the leg 132, which is fluidly connected to a source of gas.

In some embodiments, materials such as polyurethane, silicone elastomer, and copolymers of polyurethane and silicone are suitable material choices for the tube 10.

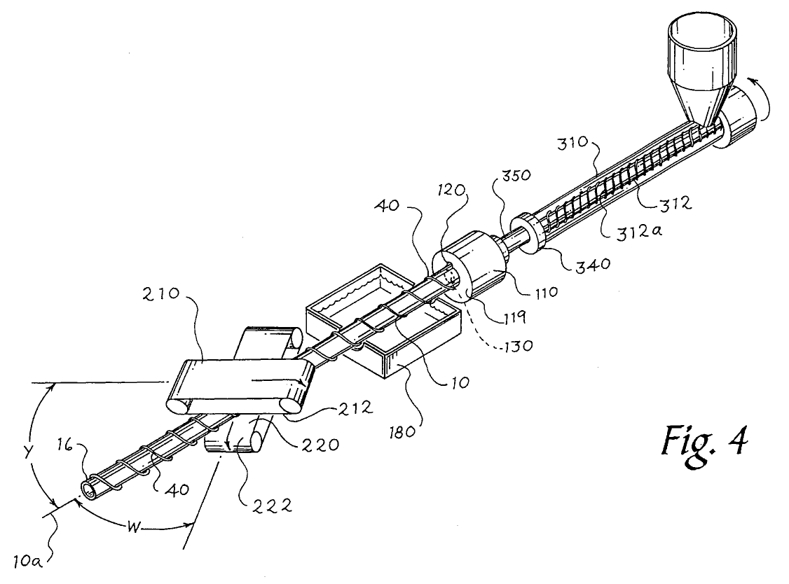

As shown in FIG. 4, a cooling bath 180 may be provided downstream of the die to receive the tube 10 as it exits the die 110. The cooling bath 180 includes a volume of water or other cooling liquid that is configured to cool the outer surface 18 of the tube 10 to prevent tube 10 from substantially deforming (either due to the weight of the material forming the tube 10 under the force of gravity or due to other causes) immediately after exiting the die 110. While the cooling bath 180 cools the tube 10, it should assist in retaining the twist the tube 10 along its length such that the protrusion 40 forms a helical shape along the outer circumference of the tube 10.

After exiting the cooling bath 180, the tube 10 travels between top and bottom belts 210, 220 such that the tube 10 extends between the receipt portions 212, 222 of each of the first and second belts 210, 220. The top and bottom belts 210, 220 are each endless continuous belts that travel between at least two rollers or other rotating members. The first and second belts 210, 220 may each be driven by separate motors or may be configured to be driven by the same motor. In some embodiments, one or more transmissions (not shown) may be rotationally attached to the motor and the belts to allow the first and second belts 210, 220 to travel at different, but related speeds based upon the motor rotational speed. In still other embodiments, the first and second belts 210, 220 may be defined from the same continuous belt, which translates in a serpentine pattern to translate through the path of each of the first and the second belts 210, 220 shown in FIG. 4.

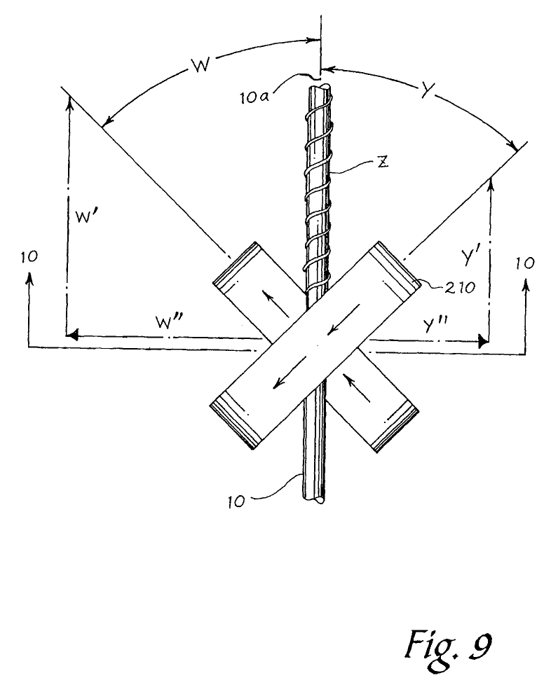

One or both of the first and second belts 210, 220 may translate along a path such that the receipt portion 212, 222 of each belt 210, 220 is at an oblique angle with respect to the longitudinal axis 10a of the tube 10. Specifically as shown in FIG. 9, the receipt portion 212 (FIG. 10) of the first belt 210 may be disposed at a first oblique angle Y with respect to the longitudinal axis 10a of the tube 10 initially contacting the first belt 210. Similarly, the receipt portion 222 of the second belt 220 may be disposed at a second oblique angle W with respect to the longitudinal axis 10a of the tube initially contacting the second belt 220.

In some embodiments, the first and second oblique angles Y, W may be the same angle, with the first and second oblique angles Y, W measured on opposite sides of the longitudinal axis 10a. In some embodiments, each of the first and second oblique angles Y, W may be within a range of between about 10 and about 80 degrees, but may be within a range of just above 0 degrees (i.e. just less than parallel with the longitudinal axis 10a) and just below 90 degrees (i.e. just less than perpendicular to the longitudinal axis 10a). In other embodiments, the first and second oblique angles Y, W may be within a range of about 25 and about 45 degrees with respect to the longitudinal axis 10a of the tube 10. The helix angle Z that the one or more protrusions 40 form upon the tube 10 is proportional to the size of the first and second oblique angles Y, W, in addition to the translational speed of the first and second belts 210, 220.

After leaving the cooling bath 180, the tube 10 is fed between the receipt portions 212, 222 of the first and second belts 210, 220 such that opposite side surfaces of the tube 10 contact the first second belts 210, 220. As the receipt portions 212, 222 of the first and second belts 210, 220 translate in the direction of their respective oblique angle Y, W the tube 10 becomes twisted along its length.

The first and second belts 210, 220 may be disposed to receive the tube 10 from the extrusion die 110, such that the protrusion 40 processes around the tube 10 in either a clockwise or a counter-clockwise manner after exiting the first and second belts 210, 220. If the first and second belts 210 were placed in the opposite orientation from that shown in FIGS. 9 and 10 (i.e. the first belt 210 contacting a bottom surface of the tube 10 and the second belt 220 contacting the top surface of the tube), each of the forces F1 and F2 (FIG. 10) would act upon the tube 10 in the opposite direction, which would cause the tube 10 to twist in the opposite direction as the direction T shown in FIG. 10, and therefore cause the protrusion 40 to process around the tube 10 in the opposite direction as well.

Specifically, the first and second belts 210, 220 are configured such that each belt contacts an opposite side of the outer surface 18 of the tube 10 and the location and orientation of the combination of belts cause the tube 10 to be slightly compressed therebetween as the first and second belts 210, 220 pull the tube 10 therealong. Due to the compressive forces placed on the opposite sides of the tube 10 and the materials of both of the first and second belts 210, 220 and the tube 10, the opposite side surfaces of the tube 10 are substantially prevented from slipping with respect to the first and second belts 210, 220. As the first and second belts continue to move, the belts provide opposing forces F1, F2 (FIG. 10) upon the outer surfaces 18 of the tube 10 that contact the respective receiving portion 212, 222 of the belt. The forces F1, F2 are generated because a portion of the respective belts motion is in a perpendicular vector component Y″, W″ direction of the first and second angles Y, W. Each of the first and second belts 210, 220 move with the vector component Y″, W″ (in addition to a vector component Y′, W′ parallel to the longitudinal axis 10a of the tube), which pulls the portion of the tube 10 contacting the respective first and second belts 210, 22 in the perpendicular direction Y″, W″.

As the opposite outer surfaces 18 of the tube 10 contacting the respective first and second belts 210, 220 are pulled in opposing directions, the tube becomes twisted along its length. Specifically, the tube 10 twists along its length in response to the opposing forces F1, F2 each aligned at substantially the same distance from the center of the tube 10. As the tube 10 twists, the tube 10 deforms plastically, which causes the tube 10 to retain at least a portion of the twist imparted thereto after the tube 10 leaves the first and the second belts 210, 220. The twisting of the tube 10 causes the one or more protrusions 40 (which are at consistent locations about the outer surface 18 of the tube 10 as the tube 10 initially engages the first and second belts 210, 220) to form a helical pattern about the outer surface 18 of the tube 10 along its length. Because the tube 10 is deformed at least partially plastically, the one or more protrusions 40 retain the helical pattern along the length of the tube 10 after leaving the first and second belts 210, 220. In some embodiments and as shown in FIG. 9, the helical pattern of the protrusion 40 (or indentation 640) is formed just after the tube 10 leaves the die 110, because the belts urge the tube 10 to twist along its length between the die 10 and the belts 210, 220. The portion of the tube 10 between the die and the belts deforms because the tube 10 leaving the die is the warmest and therefore most susceptible to deformation due to the couple presented thereto.

In some embodiments, one or both of the first and second belts 210, 220 may be movable to adjust the respective oblique angle Y, W that is formed with the longitudinal axis 10a of the tube 10. Specifically, varying the first and second oblique angles Y, W varies the perpendicular component Y″, W″ of the first and second oblique angles Y, W and therefore the magnitude of the perpendicular forces F1, F2 that act upon the opposite outer surfaces 19 of the tube 10 as the first and second belts 210, 220 translate. Varying the magnitude of the opposing perpendicular forces F1, F2 acting upon the tube 10 varies the torque placed upon the tube 10, and accordingly varies the amount that the tube twists along its length. Altering the amount of twist of the tube 10 similarly alters the helix angle Z (FIG. 9) of the one or more protrusions 40 along the length of the tube 10. As can be understood, adjusting the first and second belts 210, 220 to each have larger oblique angles Y, W increases the perpendicular components Y″, W″ of the oblique angles Y, W.

After leaving the first and second belts 210, 220, the tube 10 may be further cooled using a second cooling bath or other methods or structures to prevent the tube from further deforming, and to maintain the helix angle Z that the one or more protrusions 40 make with respect to the longitudinal axis 10a of the tube 10. The tube 10 may be cut to a desired length with a guillotine cutter, or other types of cutting devices known in the art.

In other embodiments, the first and second belts may be oriented substantially in parallel to the longitudinal axis 10a of the tube 10 leaving the cooling bath 180 and receive the tube 10 therebetween to urge the tube 10 leaving the die and cooling bath through the remainder of the extrusion mechanism and associated structure. The first and second belts may both rotate at the same speed and in the same direction about the longitudinal axis of the tube 10. The rotation of the belts causes the tube 10 to twist along its length, which causes the protrusion 40 (or indentation 640 discussed below) to form a helical pattern along the length of the tube 10. The belts may be rotated with outer auxiliary wheels (780), similar to the embodiment discussed below and shown in FIG. 12. In other embodiments, the belts may be rotated using other structures and methods that are suitable.

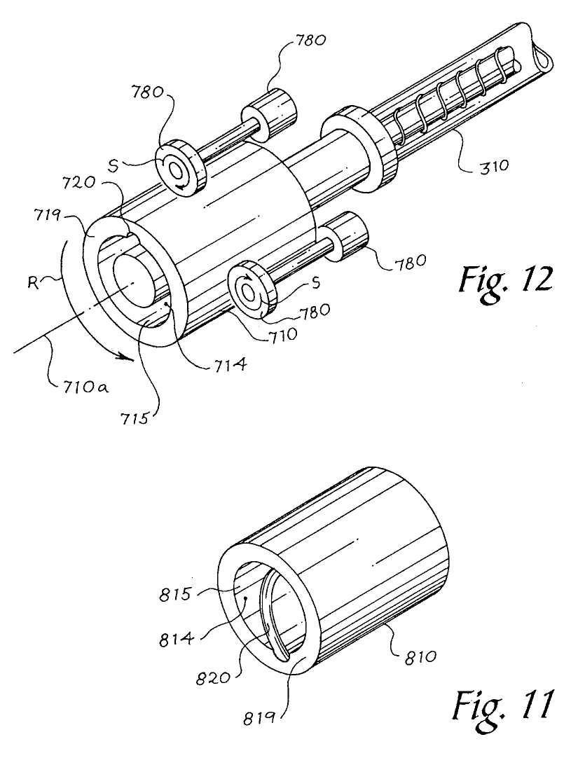

In other embodiments as shown in FIG. 11, the tube 10, including one or more protrusions 40 (or indentations 640) may be formed by an extrusion process using a single extrusion die 810. The extrusion die 810 is substantially cylindrical with an internal lumen 814 and allowing material to be pressed therethrough to form and shape the outer surface 18 of the tube 10 and include one or more protrusions 40 (or indentations 640) that extends along the length of the tube 10 in a helical pattern. Each protrusion 40 is formed from a channel 820 that projects radially from the inner cylindrical surface 815 of the die 810 radially into the wall 819 of that defines the internal lumen 814 of the die 810. The channel 820 is defined with a helical pattern along at least a portion of the longitudinal axis of the die 810. In embodiments where the tube 10 includes an indentation 640, the tooth (similar to tooth 620) on the die 810 is defined along a similar helical pattern along the length of the die 810.

As material flows through the die 810, the material at least partially hardens due to cooling before leaving the die 810, such that the lumen in the tube 10 formed by the mandrel (not shown in FIG. 11, similar to mandrel 130 of previous embodiments) does not collapse upon exiting the die 810 and the tube 10 retains its substantially cylindrical outer profile. Because the channel 820 is helical, the tube 10 within the die 810 feels torque at some point along the length of the die 810 due to the twist in the channel 820 and when the material becomes hard enough or viscous enough such that material reflow cannot keep up with the helically changing position of the channel 820 (tooth 620) along the length of the die 810. The torque imparted upon the tube 10 causes the tube 10 to twist as it flows through and leaves the die 810, which causes the protrusion 40 (or indentation 640) on the tube 10 to retain the helical pattern when leaving the die 810 as the tube 10 further cools. The protrusion 40 (indentation 640) and tube 10 may further harden soon after leaving the die 810 when flowing through a cooling bath 180 (discussed above) which causes the protrusion 40 (or indentation 640) to retain the helical pattern along the length of the tube 10.

Upon leaving the die 810, the tube 10 may extend through a cooling bath 180, similar to that discussed above. The tube 10 may be urged from the cooling bath 180 by one or two opposing belts, which receive the tube 10 exiting the cooling bath and “pull” the tube 10 along the bath 180 and out of the extrusion device. The belts are aligned to run in parallel with the longitudinal axis of the tube 10 leaving the bath such that the tube 10 is not rotated. The tube 10 leaving the belts may be further processed as necessary to prepare the final product.

In other embodiments shown in FIG. 12, the tube 10, including the one or more protrusions 40 (or indentations 640), may be formed by an extrusion process with an alternate single extrusion die 710. The extrusion die 710 is substantially cylindrical with an internal lumen 714 for receiving and allowing material to be pressed therethrough to form and shape outer surface 18 of tube 10. Flowing material (i.e. heated to a flowing liquid state with minimal viscosity) is presented to the inlet of the extrusion die 710 and is directed to enter the lumen 714 within the extrusion die 710. In some embodiments, the liquid material may be urged toward the extrusion die 710 with an Archimedes screw, or auger 312 within a heated barrel 310, as discussed in the embodiments above. The extrusion die 710 further defines at least one channel 720 or tooth (not shown but representative of tooth 620) that projects radially from the inner cylindrical surface 715 of the die 710 radially into the wall 719 that defines the internal lumen 714 (or the tooth extends radially into the lumen 714 from the wall 719).

The die 710 is configured to rotate about its longitudinal axis 710a such that the location where protrusion 40 (or indentation similar to indentation 640) leaves the die 710 rotates about the circumference of the tube 10. Accordingly, the protrusion 40 (or indentation 640) is helically formed along the length of the tube 10, with the protrusion 40 being monolithically formed with the tube wall. The die 710 may be fixably mounted to the remainder of the tube formation apparatus to rotate at a constant or varying speed, which alters the helix angle of the protrusion 40 on the tube 10.

The die 710 (similar to die 110 discussed above) may be rotatably fixed to the remainder of the tube formation apparatus with many different structures or mechanisms. For example, as shown in FIG. 12, the outer surface of the die 710 may contact a plurality of rotatable wheels 780 positioned upon an outer cylindrical surface of the die 710. The wheels 780 each contact the outer surface of the die 710 with sufficient normal force therebetween to substantially prevent slippage between the wheels 780 and the outer surface of the die 710. The wheels 780 may each be rotated in the same direction S by one or more motors 786, with or without one or more transmissions therebetween. As the wheels are rotated, the die 710 is rotated in the opposite rotation direction R, which causes the rotational position of the protrusion 40 (or indentation 640) to vary as the die 710 rotates. In other embodiments, the die 710 may be rotated using other methods and structures that are suitable.

Upon leaving the die 710, the tube 10 may extend through a cooling bath 180, similar to that discussed above. The tube 10 may be urged from the cooling bath 180 by one or two opposing belts, which receive the tube 10 exiting the cooling bath and “pull” the tube 10 along the bath 180 and out of the extrusion device. The belts are aligned to run in parallel with the longitudinal axis of the tube 10 leaving the bath such that the tube 10 is not rotated. The tube 10 leaving the belts may be further processed as necessary to prepare the final product.

While the preferred embodiments of the invention have been described, it should be understood that the invention is not so limited and modifications may be made without departing from the invention. The scope of the invention is defined by the appended claims, and all devices that come within the meaning of the claims, either literally or by equivalence, are intended to be embraced therein.

What is claimed is:

1. A flexible tube comprising:
a distal end portion, a proximal end portion, and a lumen extending therebetween;
a tube wall circumferentially defining the lumen and an outer surface surrounding the tube wall;
a protrusion substantially helically extending between the distal and proximal end portions, wherein the raised portion is monolithically formed within the tube wall.

2. The flexible tube of claim 1, wherein the protrusion comprises a plurality of raised portions helically extending between the distal and proximal end portions.

3. The flexible tube of claim 1, wherein the raised portion extends helically around the outer surface surrounding the tube wall at a helix angle of between about 5 degrees and about 45 degrees with respect to a length of the tube wall.

4. The flexible tube of claim 1, wherein the raised portion is at least partially collapsible toward the tube wall.

5. A method of manufacturing a flexible tube, comprising the steps of:
providing a source of material to be extruded;
forming a tubular member with an extrusion die that defines a lumen and a channel extending radially from a substantially cylindrical surface defining the lumen, the channel configured to define a protrusion monolithically upon an outer surface of the tubular member; and
rotating the tubular member such that the protrusion forms a substantially helical profile along the length of the tubular member.

6. The method of claim 5, wherein the extrusion die comprises a wall that defines the lumen by an internal cylindrical surface within the wall, wherein the channel radially extends into the wall from the internal surface.

7. The method of claim 8, wherein the extrusion die is rotated with respect to a longitudinal axis of the tube.

8. The method of claim 6, wherein the channel within the extrusion die extends in a substantially helical pattern along at least a portion of a length of the extrusion die.

9. The method of claim 6, wherein the tubular member is rotated by translation of a first belt and a second belt that each receive the tubular member therebetween.

10. The method of claim 9, wherein the first and the second belt each rotate about a longitudinal axis of the tubular member.

11. The method of claim 9, wherein the first belt and the second belt each contact substantially opposite outer surfaces of the tubular member.

12. The method of claim 9, wherein the first belt is disposed at a first oblique angle with respect to a longitudinal axis of the tubular member exiting the extrusion die and the second belt is disposed at a second oblique angle with respect to the longitudinal axis, wherein the first and second oblique angles are disposed on opposite sides of the longitudinal axis.

13. The method of claim 11, wherein the first and second oblique angles are substantially the same angle with respect to the longitudinal axis.

14. The method of claim 9, wherein the flexible tube contacts the first and the second belts approximately simultaneously.

15. The method of claim 5, wherein the extrusion die comprises a plurality of channels extending radially from the lumen.

16. An apparatus for manufacturing a tube comprising:
a distribution member configured to receive and transport a quantity of flowing material therethrough;
an extrusion die comprising a wall defining a lumen with an inner substantially cylindrical surface of the wall, and a channel extending radially from the inner substantially cylindrical surface into the wall, the die configured to receive the flowing material from the distribution member and produce a tubular structure with a protrusion along its length; and
a first belt and a second belt each disposed to receive the tubular structure after exiting the extrusion die, wherein the first and second belts each contact a substantially opposite outer surface of the tubular structure, wherein the first belt is disposed at a first oblique angle with respect to a longitudinal axis of the tubular member, and the second belt is disposed at a second oblique angle with respect to the longitudinal axis on an opposite side of the longitudinal axis from the first belt.

17. The apparatus of claim 16, further comprising a cooling bath disposed between the extrusion die and the first and second belts.

18. The apparatus of claim 16, wherein the first and second belts are configured to slightly compress the tubular structure therebetween to substantially prevent the tubular structure from slipping with respect to the first and second belts.

19. The apparatus of claim 16, wherein the extrusion die further comprises a second channel radially extending from the inner cylindrical surface and into the wall.

20. A flexible tube comprising:
a distal end portion, a proximal end portion, and a lumen extending therebetween;
a tube wall circumferentially defining the lumen and an outer surface surrounding the tube wall; and
an indentation substantially helically extending between the distal and proximal end portions, wherein the indentation is monolithically formed within the tube wall.

21. The flexible tube of claim 20, wherein the indentation comprises a plurality of indentations helically extending between the distal and proximal end portions.
